(19) United States
(12) Patent Application Publication
(10) Pub. No.: US 2017/0188753 A1
(43) Pub. Date: Jul. 6, 2017

(54) TOASTER WITH ENHANCED FUNCTIONALITY

(71) Applicant: Geoff Hall, Solihull (GB)

(72) Inventor: Geoff Hall, Solihull (GB)

(21) Appl. No.: 14/983,534

(22) Filed: Dec. 30, 2015

(51) Int. Cl. A47J 37/08; A23L 5/10

(52) U.S. Cl. CPC A47J 37/0842; A47J 37/0871; A23L 5/15; A23V 2002/00

(57) ABSTRACT

A toaster which has a plurality of pre-configured buttons which each have their respective pre-defined quantities for time and duration that the toast (or any other food that fits into the toaster) will cook for. An adjustment dial is present which adjusts the time to cook which modifies the time that the selected button will cook for. In this manner, a user can easily control the parameters that the toaster will cook for so the desired consistency of toast can be achieved.

### BACKGROUND OF THE INVENTION

Field of the Invention

The present general inventive concept is directed to a method, apparatus, and computer readable storage medium directed to a toaster with enhanced functionality.

Description of the Related Art

Toasters can have an adjustment dial which controls the duration in which the toast is heated before it pops out of the toaster.

What is needed is a toaster which has convenient settings in which a user can conveniently choose particular types of toast which require changes in temperature as well as duration.

### SUMMARY OF THE INVENTION

It is an aspect of the present invention to provide an improved toaster.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is drawing of a toaster which has a plurality of pre-configured toast type buttons, according to an embodiment;

FIG. 2 is a drawing of a toaster with a knob instead of the toast type buttons, according to an embodiment;

FIG. 3 is a flowchart illustrating an exemplary method of using a toaster, according an embodiment;

FIG. 4 is a flowchart illustrating an exemplary method of determining the heating time and duration from the pressed button and the adjustment dial, according to an embodiment; and

FIG. 5 is a block diagram illustrating components that are part of the toaster, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a toaster which has a set of controls which enable a user to easily conveniently set the cooking parameters. The toaster can have a plurality of buttons with different “crunchiness” settings which control both the temperature of the heating elements and the duration that the toast will cook for (before the toast is popup up in the air and the heating element is turned off). Each of the crunchiness settings is preconfigured for a particular temperature and duration. An adjustment dial then further adjusts the duration for the button chosen. Thus, the adjustment dial serves as the “fine tuning” to further adjust the “crunchiness” of the toast (by adjusting the cooking duration).

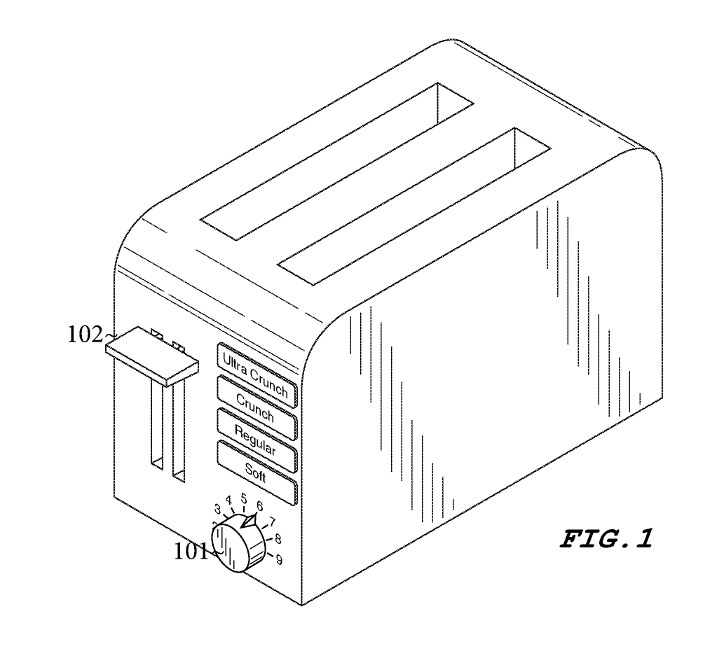

FIG. 1 is drawing of a toaster which has a plurality of pre-configured toast type buttons, according to an embodiment.

A toaster accepts two pieces of toast in the two slots on top and a lever 102 when pressed will lower an arm (not pictured) and thereby lowering the toast into the toaster. There is a toast floor inside the slots (not pictured) which is raised (and lowered) by the arm. When the arm is pressed, the toast floor lowers there by lowering the toast in the slots into the toaster body. The lever and arm all operate as a standard prior art toaster would.

A set of four buttons (although there could be any number of buttons and any other type of input device) are labeled “ultra-crunch”, “crunch”, “regular”, “soft” and each have their own factory preset quantities for temperature and durations. For example, Table I illustrates a set of buttons and their corresponding temperatures and durations (cooking time before the heating element is turned off). Note that these are merely examples and other values can be used as well. There can also be any other number of such buttons (e.g., 2-10). The temperature is given in degrees Celsius and the duration is given in minutes: seconds.

TABLE I

| Setting | temperature | duration |
|---|---|---|
| Ultra crunch | 125 | 4:00 |
| Crunch | 140 | 3:30 |
| Regular | 155 | 3:00 |
| Soft | 165 | 2:30 |

Thus, for example, if the user pressed the “Crunch” button before toasting, then once the lever is pulled, the toaster will automatically cook for 3:30 seconds at 140 degrees Celsius. These are factory settings (quantities) and the user would not be able to change these presets.

Turning an adjustment dial 101 will adjust the duration of the cooking (but not the temperature). The effect of the adjustment dial will be discussed below in more detail.

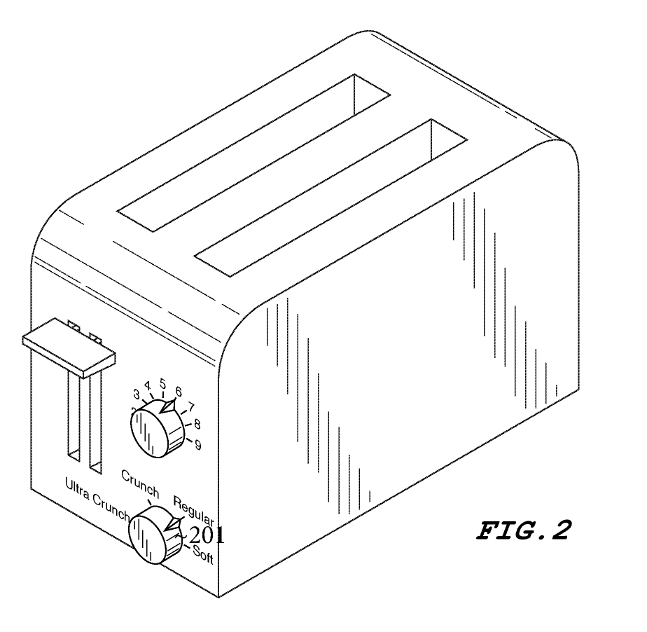

FIG. 2 is a drawing of a toaster with a knob instead of the toast type buttons, according to an embodiment;

In FIG. 2, a toast type knob 201 is used instead of the set of buttons illustrated in FIG. 1. Note that the toast type knob 201 causes the same operation as the buttons (the setting chosen will have the same effect). There is an input device to set the toast type (e.g., the toast type knob 201 in FIG. 2 and the toast type buttons in FIG. 1) and it does not matter what type of input device is used (e.g., buttons, knob, dial, slider, etc.) to set this parameter. There is also an input device used set the adjustment level (e.g., the adjustment knob 101) and it does not matter what type of input device is used (e.g., buttons, knob, dial, slider, etc.) to set this parameter. While there are four toast types, there can be more toast types or less toast types. While the adjustment dial shows levels from 1 through 9), it can also be appreciated that there can be any other range of levels (e.g., 1 to 5, etc.)

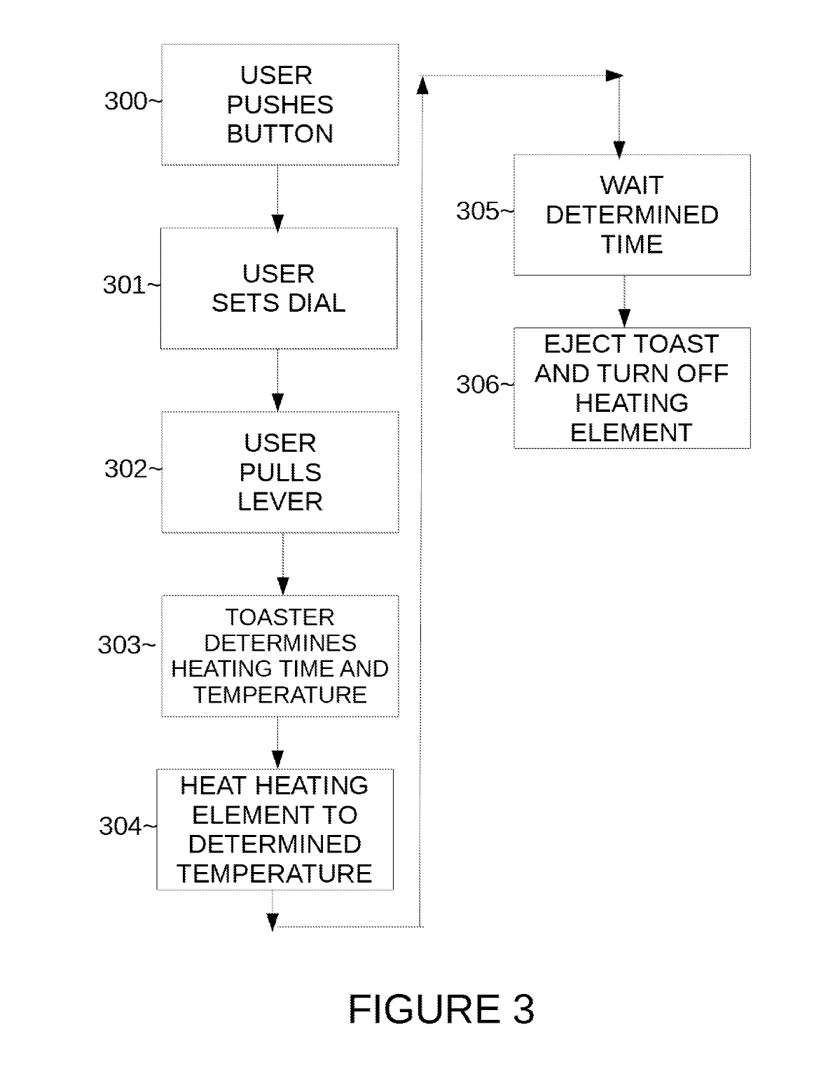

FIG. 3 is a flowchart illustrating an exemplary method of using a toaster, according to an embodiment.

In operation 300, the user pushes one of the four (or other number depending on how many such buttons are on the toaster) setting buttons. One of these buttons must be pushed. The buttons can be electronic (e.g., no physical depression occurs but the pressed button will physically light up) or physical (the pressed button will actually push in (be depressed) thereby automatically raising the previously depressed button).

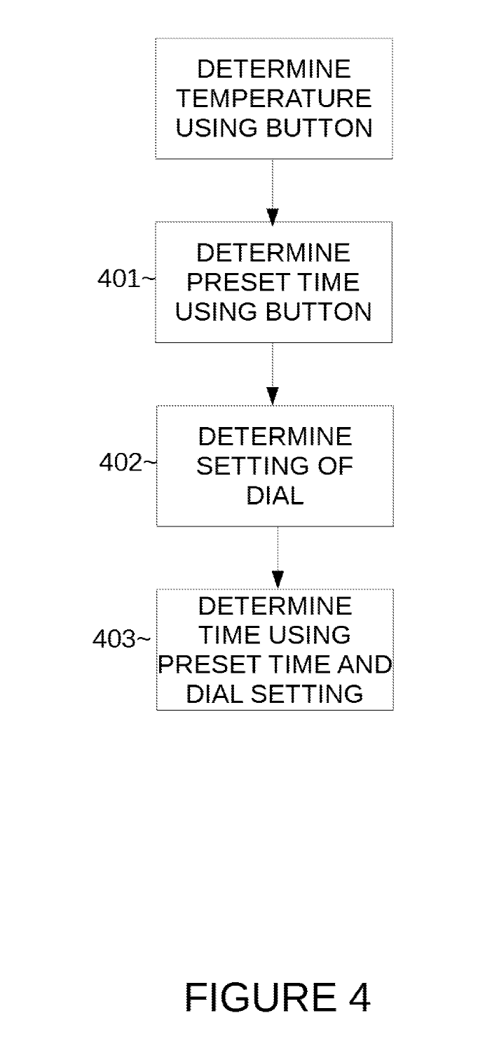

From operation 300, the method proceeds to operation 301, wherein the user sets the adjustment dial to the user's desired value. The user can also just leave the adjustment dial in the same value as it currently already is if the user has no desire to change it. The adjustment dial is an analog physical dial that turns but it can be a digital dial (or up/down buttons) as well. The adjustment dial will adjust the cooking time, but not the temperature. Turning the adjustment dial higher will lengthen the cooking time. More on how the adjustment dial operates is discussed with regard to FIG. 4.

From operation 301, the method proceeds to operation 302, wherein the user puts in the toast and pulls the lever down. This automatically lowers the arm (and hence the toast) into the toaster.

From operation 302, the method proceeds to operation 303, wherein the toaster determines the heating time (duration) and the temperature. This is done as illustrated in FIG. 4 and described herein.

From operation 303, the method proceeds to operation 304, which activates (heats up) the heating element to the desired temperature. This will begin the actual cooking of the toast.

From operation 304, the method proceeds to operation 305, which waits the determined time (from operation 303). The heating elements will remain at the determined temperature during this operation. Note that it may take some time for the heating element to warm up to the determined temperature but this warm-up time is also counted in the time waited in operation 305.

From operation 305, once the determined time has occurred, then the method proceeds to operation 306 which completes the cooking process. The toast is ejected by automatically raising the arm and the heating element is turned off. A sound (such as a bell, chime, etc.) can optionally sound as well notifying the user that the cooking is completed.

Note that operation 303 can also be performed in between operations 301 and 302 as well. This will not have any practical effect on the performance of the method.

FIG. 4 is a flowchart illustrating an exemplary method of determining the heating time and duration from the pressed button and adjustment dial value, according to an embodiment. FIG. 4 is performed as operation 303 in FIG. 3.

In operation 400, the temperature of the heating element is determined using the button pressed. This can be performed by (the processing unit) using a lookup table such as Table I and using the value which corresponds to the particular button pressed. Other electrical methods of accomplishing this can be achieved as well. The toaster circuit can have a hardware quantity physically hardwired to each button which when pressed, would be activated and transmits the hardwired value to the heating element (or the processing unit). In another embodiment, the quantities for each button (temperature and duration) can be stored on a computer readable memory (e.g., ROM, EPROM, etc.) and used as a look up table. Any configuration and analog and/or digital circuits can be configured to achieve the lookup feature.

If for some reason, the system cannot register a pressed button this could mean a malfunction. This situation could be handled either by 1) not activating the heating element until a button press is registered, or 2) by default using the “regular” button quantities.

From operation 401, the method proceeds to operation 402, which determines the value of the adjustment dial (can also be referred to as adjustment knob). The adjustment dial can simply be an analog potentiometer, a digital knob, etc. Any such input device can be used so long as the position of the knob can be transmitted to the processing unit (or any other circuitry). The knob can be discrete in that only the whole numbers can be selected (e.g., 1, 2, 3, etc.) or it can be continuous in that it can be set between whole numbers (e.g., 1.5, 2.3, etc.)

From operation 402, the method proceeds to operation 403, which receives the value of the adjustment dial and computes the time (which will be the heating time before the heating element shuts off). The “duration” as used herein is synonymous with time. The adjustment dial generally is used to “fine tune” and augment the duration the toaster will cook before turning off. There can be numerous ways that the time can be determined based on the duration.

The adjustment dial will typically be numbered from 1 to 9. If the adjustment dial is set to 1, then there will be no increase of the time from what the selected button would dictate what the time would be. For example, if the button pressed is “ultra crunch” then the time would be 4 minutes (from Table I) as there would be no increase in these predetermined times.

However, turning the adjustment dial above 1 would increase the time. For example, turning the adjustment dial to 2 would increase the time, turning the adjustment dial to 3 would increase the time to more than the adjustment dial at 2 would, turning the adjustment dial to 4 would increase the time to more than the adjustment dial set of 3 would, etc. The higher the adjustment dial is set, the more the time would increase over the standard time for the button selected. There can be numerous ways that the increased time is determined.

In one embodiment, a simple table can be used such as Table II to determine how much time (in seconds) to add to the time based on the button pressed. Table II shows two sample embodiments, embodiment A shows a constant increase in time per increase in adjustment dial value while embodiment B shows a diminishing increase in time pre increase in adjustment dial value.

TABLE II

| | Time added | Time added |
|---|---|---|
| Adj. Dial value | (embodiment A) | (embodiment B) |
| 1 | 0 | 0 |
| 2 | 10 | 10 |
| 3 | 20 | 20 |
| 4 | 30 | 27 |
| 5 | 40 | 34 |
| 6 | 50 | 40 |
| 7 | 60 | 45 |
| 8 | 70 | 50 |
| 9 | 80 | 54 |

In addition to using the table approach illustrated in Table II, a formulaic approach can also be used. For example, if t is the time added, d is the adjustment dial value from 1 to 9), and p is the preset time (the time based on the button selected, for example see Table I), then one such relationship can be used: t=p+(d-1)*c, wherein c is a non-zero constant. The constant c can be set by the engineers of the toaster and can be any number, for example, 5. Typically c should be in a range from 1 to 50 (t and p are all in seconds), although c can be less than 1 as well.

In a further embodiment, the increase in time based on the adjustment dial will diminish with higher adjustment dial values. For example, the following relationship can be used: t=p+(sqrt(d-1)*c). In this embodiment, when the adjustment dial is set to 1, there is no time added to the preset time for the current button pressed (e.g., if “soft” is pushed then the preset time (p) is 2:20 from Table I). As the adjustment dial is increased, the increase in time will get smaller and smaller. The constant c can be any positive number, for example 40 but can be any number from 1 to 100 or higher).

Note that the adjustment dial can be discrete (will snap into position only round numbers) or continuous (can be set to positions between numbers). In a discrete embodiment, the value of the adjustment dial will be rounded to the nearest whole number and then that number is used to determine the time duration. In a continuous embodiment, the value of the adjustment dial will be transmitted accurately and can be between numbers (e.g., 1.4) and that number is used in the formulas being used to determine the time duration.

In a further embodiment, the time duration increase based on the adjustment dial value would vary based on the button pressed. For example, lower temperatures (e.g., from Table 1) would result in an addition to the preset time (p) of a longer duration for the adjustment dial while higher temperatures would result in an addition to the preset time (p) of a lower duration for the adjustment dial. For example, a table such as Table III can be used to determine the addition of time (y) from the preset time (t) based on the adjustment dial value. Note that the values in Table III (and in fact all values used herein) are merely exemplary and other values can be used as well.

TABLE III

| Dial value | Soft | Regular | Crunch | Ultra Crunch |
|---|---|---|---|---|
| 1 | 0 | 0 | 0 | 0 |
| 2 | 10 | 12 | 15 | 20 |
| 3 | 20 | 22 | 25 | 30 |
| 4 | 30 | 32 | 35 | 40 |
| 5 | 40 | 42 | 45 | 50 |
| 6 | 50 | 52 | 55 | 60 |
| 7 | 60 | 62 | 65 | 70 |
| 8 | 70 | 72 | 75 | 80 |
| 9 | 80 | 82 | 85 | 90 |

In this embodiment, the additional time added to the preset time based on the adjustment dial value is determined by a table which utilizes the current setting. In the example given, the settings with the lower temperatures will have longer increases based on the adjustment dial. This is beneficial because lower temperatures would generally require longer cook times.

In an embodiment, if a table such as Table II is used to determine the time added, then the embodiment which depends upon the setting can utilize a setting factor to increase the time based upon the setting. For example, Table IV below illustrates different setting factors. Note that the values given are merely examples and can be any number.

TABLE IV

| Setting | Setting Factor |
|---|---|
| Ultra crunch | 2 |
| Crunch | 1.5 |
| Regular | 1.25 |
| Soft | 1 |

For example, using Table II, if the setting chosen is ultra crunch, and the adjustment dial is set on 2, then (in either embodiment A or B) the time added is 10 seconds. Because (using Table IV) the setting factor for ultra crunch is 2, then the time added is multiplied by 2, thus 10*2=20. Thus, the time added will be 20 seconds. Using the tables in Table IV, if the setting is on soft, then the setting factor is 1 which means there is no adjustment to the computed setting. Applying the setting factor can be applied to both the table approach as well as the formulaic approach. Basically it is just increasing the computed time added (based on the adjustment dial value) by a variable amount based on the button pressed (setting). Generally, the time increased based on the adjustment dial value should be increased when the temperature used is relatively lower to make sure the toast (or other item cooked) is adequately cooked.

Using any of the formulaic approaches, the constant c can be increased based upon the setting. Table V illustrates an example of using different constants based on the setting (the button pressed). Note that the values in Table V are merely examples and other values for the constants can be used.

TABLE V

| Setting | constant |
|---|---|
| Ultra-crunch | 65 |
| Crunch | 50 |
| Regular | 40 |
| Soft | 35 |

Thus, for example, using any of the formulaic approaches described herein, the constant (c) used would be determined by the setting of the button. In this way, the settings with the lower temperatures would have the time added based on the adjustment dial value increased more than the settings with the higher temperatures.

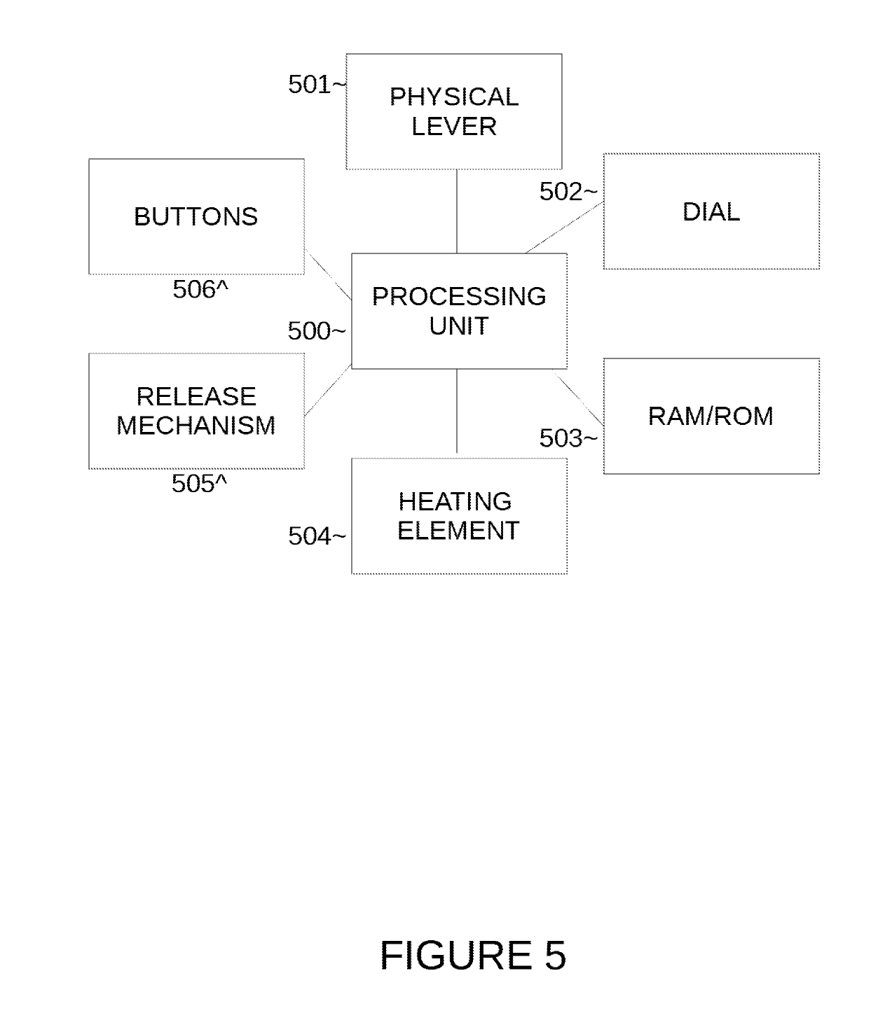

FIG. 5 is a block diagram illustrating components that are part of the toaster, according to an embodiment.

A processing unit 500 can be a microprocessor and associated hardware (e.g., cache, bus, power supply, etc.) The processing unit 502 is connected to an adjustment dial 502 so that the processing unit 500 can detect the value the adjustment dial 502 is turned at. The processing unit 400 is also connected to a set of buttons 506 so that the processing unit can detect which button was last pressed. The processing unit 500 is also connected to a heating element 404 so that the processing unit 500 can activate (turn on) the heating element 504 and deactivate (turn off) the heating element, and also control the temperature of the heating element 504. The processing unit 500 can also be attached to a release mechanism 505 so when the toast is done cooking (the computed duration to cook has expired) then the lever 102 can be raised (and optionally an audible alert such as a bell can be sounded). The processing unit 500 can also be attached to the physical lever 501 so that the processing unit 500 can detect when the lever has been pressed down. The processing unit 500 can also be connected to a ROM 503 and/or a RAM 503, the ROM can be used to store a program to control the processing unit to implement all of the methods/features described herein and the RAM can be used as temporary memory which may be needed to implement all of the methods/features described herein.

In addition to a ROM, there can be a computer storage medium (e.g., EPROM, hard drive, etc.) that stores a computer program that would instruct (cause) the processing unit 400 to implement all of the methods described herein.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A toaster, comprising:
a heating element;
a lever;
at least one slot;
a toast type input device;
a circuit comprising at least one processor connected to a computer readable memory, the computer readable memory storing computer readable instructions programmed to cause the at least one processor to perform:
determine a temperature and a duration based on a toast type set on the toast type input device; and
upon activation of the lever, heat the heating element at the temperature only for the duration.

2. The toaster as recited in claim 1, wherein the computer readable instructions are further programmed to eject contents of the at least one slot when the preset time has expired after activation.

3. The toaster as recited in claim 1, wherein the toast type input device comprises a set of buttons;

4. The toaster as recited in claim 1, further comprising an adjustment input device.

5. The toaster as recited in claim 1, wherein the adjustment input device is a dial.

6. The toaster as recited in claim 4, wherein the computer readable instructions are further programmed to increase the duration by an amount based on a set value of the adjustment input device.

7. The toaster as recited in claim 6, wherein the computer readable instructions are further programmed such that the amount is also based on the toast type set.

8. The toaster as recited in claim 7, wherein the computer readable instructions are further programmed such that the amount is higher when the temperature is lower.

9. A method, comprising:
providing a toaster, comprising:
a heating element;
a lever;
at least one slot;
a toast type input device;
receiving toast in the at least one slot;
activating the lever;
determining a temperature and a duration based on a toast type set on the toast type input device; and
upon activation of the lever, heat the heating element at the temperature only for the duration.

10. The method as recited in claim 9, further comprising, after the duration has expired after the activation, ejecting contents of the slot.

11. The method as recited in claim 9, wherein the method further comprises further providing an adjustment input device;

12. The method as recited in claim 11, further comprising increasing the duration by an amount based on a set value of the adjustment input device.

13. The method as recited in claim 11, further comprising increasing the duration by an amount based on a set value of the adjustment device and also based on the toast type set.

14. The toaster as recited in claim 11, further comprising increasing the duration by an amount based on a set value of the adjustment input device such that the amount is higher when the temperature is lower and also increasing the duration based on the toast type set.

15. The toaster as recited in claim 11, wherein the adjustment input device is a dial.

16. The toaster as recited in claim 11, wherein the toast type input device comprises a set of buttons.
